(19) United States
(12) Patent Application Publication
(10) Pub. No.: US 2004/0147172 A1
(43) Pub. Date: Jul. 29, 2004

(54) Apparatus, system, and method of electrically coupling photovoltaic modules

(76) Inventors: Jacob E. Brown, Corona del Mar, CA (US); Teodor M. Galitev, Fountain Valley, CA (US); Keith Volz, Jamestown, NC (US)

Correspondence Address: MORGAN LEWIS & BOCKIUS LLP, 1111 PENNSYLVANIA AVENUE NW, WASHINGTON, DC, 20004, US

(21) Appl. No.: 10/612,873

(22) Filed: Jul. 7, 2003

Related U.S. Application Data
(60) Provisional application No. 60/393,379, filed on Jul. 5, 2002.

(51) Int. Cl. H01R 13/502

(52) U.S. Cl. 439/701

(57) ABSTRACT

A system and method of electrically connecting direct current components of photovoltaic system that is mounted on a structure, which includes an alternating current electrical system. The direct current components of the photovoltaic system include a photovoltaic module that has a frame, a photovoltaic module positive node, and a photovoltaic module negative node. The method includes coupling a plug connector to the photovoltaic module, which includes electrically coupling a first wire to the photovoltaic module positive node, electrically coupling a second wire to the photovoltaic module negative node, and electrically coupling a ground wire to the frame of the photovoltaic module.

### CROSS-REFERENCE TO RELATED APPLICATIONS

This application claims the benefit of the earlier filing date of U.S. Provisional Application No. 60/393,379, filed 5 Jul. 2002, the entirety of which is incorporated by reference herein.

### FIELD OF THE INVENTION

Systems for converting solar energy to electrical energy often include a set of photovoltaic cells, a.k.a. “solar cells,” which are mounted on a common base and are electrically interconnected. Such a set of cells can be referred to as a photovoltaic module. It is frequently the case that pluralities of these modules are used together to obtain a desired electrical output, i.e., a specified voltage and current. Inasmuch as these modules are often mounted on top of buildings, it is desirable to provide convenient apparatuses, systems, and methods to install and service the modules.

### BACKGROUND OF THE INVENTION

It is believed that known systems of photovoltaic modules suffer from a number of disadvantages, including requiring an electrician or specialized solar technician to make electrical connections on the backside of the known photovoltaic modules. The electrician must remove the cover of a junction box for each photovoltaic module, fish wires through a strain relief tube or conduit, cut and strip the wires, connect the wires to the terminal strip being careful not to cross polarity or touch the wires (the system is electrically active if the sun is out), and then replace the junction box cover. Moreover, these known systems use wire nuts, soldered connections, etc. that are difficult to use in the environments in which the module elements 100 are frequently located. Another disadvantage of known systems is that the relative placement of photovoltaic modules is limited by constraints on the availability and access to junction boxes for making electrical connections.

It is believed that there is a need to overcome the disadvantages of the known systems of photovoltaic modules.

### SUMMARY OF THE INVENTION

According to the present invention, a photovoltaic module can be electrically connected or disconnected without tools. The phrases “without tools” and “manual attachment” refer to a technician performing a task without the use of any hand tools or power tools. Thus, it is possible according to the present invention to simplify and speed up the installation, removal, and replacement of photovoltaic modules, and thereby reduce the amount of time on the top or sides of a structure, e.g., a building, while performing these tasks. It is also possible according to the present invention to improve safety by virtue of a service person being able to easily and safely, e.g., with minimal shock hazard, connect and disconnect photovoltaic modules or other components of the photovoltaic system

The present invention provides a system of electrically connecting a photovoltaic module. The photovoltaic module includes a plurality of photovoltaic cells and a frame that mechanically couples the plurality of photovoltaic cells. Each of the plurality of photovoltaic cells receives solar energy and outputs direct current electricity. The outputs of the plurality of photovoltaic cells are combined and provided at photovoltaic module positive and photovoltaic module negative nodes. The system includes a wire assembly and a first plug connector. The wire assembly is a first wire, a second wire, and a third wire. The first wire extends between respective first and second ends, and the first end of the first wire is electrically coupled to the photovoltaic module positive node. The second wire extends between respective first and second ends, and the first end of the second wire is electrically coupled to the photovoltaic module negative node. The third wire extends between respective first and second ends, and the first end of the third wire is electrically coupled to the frame of the photovoltaic module. The first plug connector includes a set of terminals that are arranged in a relative pattern. The set of terminals is a first terminal, a second terminal, and a third terminal. The first terminal is electrically coupled to the second end of the first wire, the second terminal electrically coupled to the second end of the second wire, and the third terminal is electrically coupled to the second end of the third wire.

The present invention also provides a photovoltaic module to be mounted on a structure. The photovoltaic module includes first and second module faces and an edge that extends between the first and second module faces, a plurality of photovoltaic cells that are commonly supported by a base, and a junction box that is supported on the base along the edge and shields electrical couplings to the plurality of photovoltaic cells. The first module face receives solar energy and the second module face generally confronts the structure. Each of the photovoltaic cells converts the solar energy to electricity. The junction box includes a first one of a male plug connector and a female plug connector. The first one of the male and female plug connectors is accessible from the first module face and matingly couples with a second one of the male and female plug connectors so as to output the electricity from the e plurality of photovoltaic cells.

The present invention also provides a kit including a photovoltaic module and a wiring assembly. The photovoltaic module includes first and second module faces and an edge that extends between the first and second module faces, a plurality of photovoltaic cells being commonly supported by a frame, and a junction box supported on the frame along the edge. The first module face receives solar energy such that each of the plurality of photovoltaic cells receives solar energy and outputs direct current electricity. The outputs of the plurality of photovoltaic cells are combined and provided at photovoltaic module positive and photovoltaic module negative nodes. The junction box shields the photovoltaic module positive and photovoltaic module negative nodes, and includes a first one of a male plug connector and a female plug connector. The first one of the male and female plug connectors being accessible from the first module face. The wire assembly includes a second one of the male and female plug connectors matingly coupling with the first one of the male and female plug connectors. The second one of the male and female plug connectors includes a set of terminals consisting essentially of first, second, and third terminals.

The present invention also provides a method of electrically connecting direct current components of photovoltaic system that is mounted on a structure, which includes an alternating current electrical system. The direct current components of the photovoltaic system include a photovoltaic module that has a frame, a photovoltaic module positive node, and a photovoltaic module negative node. The method includes mounting the photovoltaic module with respect to the structure, and electrically connecting without tools the photovoltaic module to another one of the direct current components.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention.

FIG. 1 is a schematic illustration of a grid-tie solar electric system according to a preferred embodiment of the present invention.

FIG. 2 illustrates an array of four photovoltaic modules according to a preferred embodiment of the present invention.

FIG. 3 is a detail view of the “Viewed Area” indicated in FIG. 2.

FIG. 4 is an exploded perspective view of a plug connector according to a preferred embodiment of the present invention, including one view of a male plug connector and two views from opposite ends of a female plug connector.

FIG. 4A is a detail view explaining the features of the male and female plug connectors.

FIGS. 5A-5D illustrate exemplary uses for the plug connector illustrated in FIG. 4.

FIGS. 6A-6C illustrate an exemplary arrangement for using the plug connector illustrated in FIG. 4.

FIGS. 7A-7C illustrate an exemplary method of using the plug connector illustrated in FIG. 4.

### DESCRIPTION OF PREFERRED EMBODIMENTS

According to preferred embodiments of the present invention, a photovoltaic panel including a junction box may be connected or disconnected without tools and with a minimum of time spent at the installation site, which is frequently at altitude on the top or sides of a building. Thus, each photovoltaic panel according to the present invention can be electrically interconnected using a standardized system of wires and plug connectors.

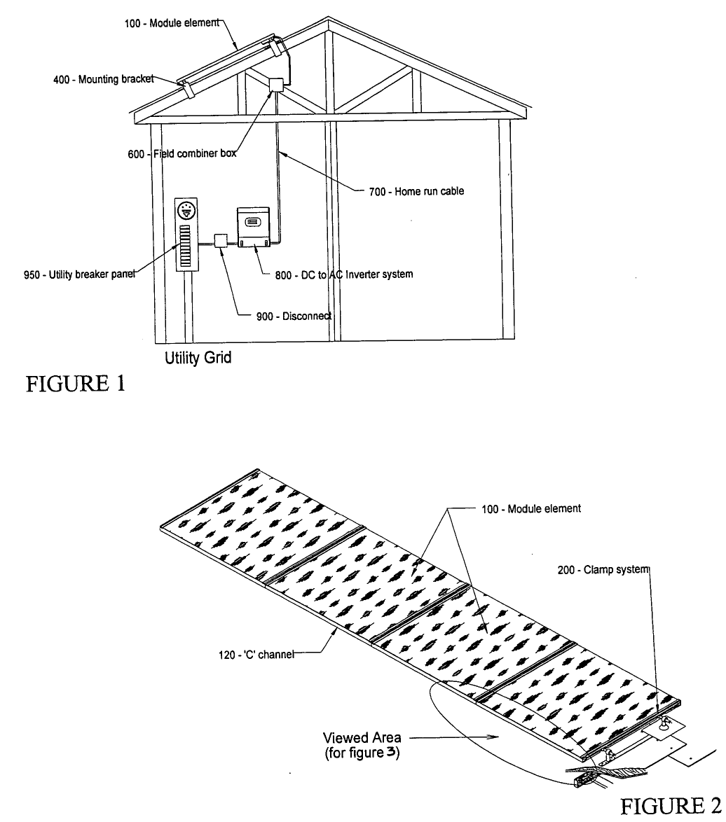

FIG. 1 shows an example of a grid-tie solar electric system according to a preferred embodiment of the present invention. According to the present invention, a pre-engineered and approved kit, which includes photovoltaic modules and “plug-and-play” type electrical connectors, can be used in a solar electric system package. A solar electric system package will consist of all components needed for a complete and easy installation of the photovoltaic system. For example, pluralities of solar electric modules 100 are secured via a mounting system 200 to a structure, e.g., a building. A field combiner box 600 electrically connects the outputs of at least some of the solar electric modules 100. One or more home run cable(s) 700 electrically couples the field combiner box(es) 600 to an inverter 800. And a utility disconnecting device 900 electrically connects and disconnects the inverter 800 with respect to a breaker panel 950 for the structure.

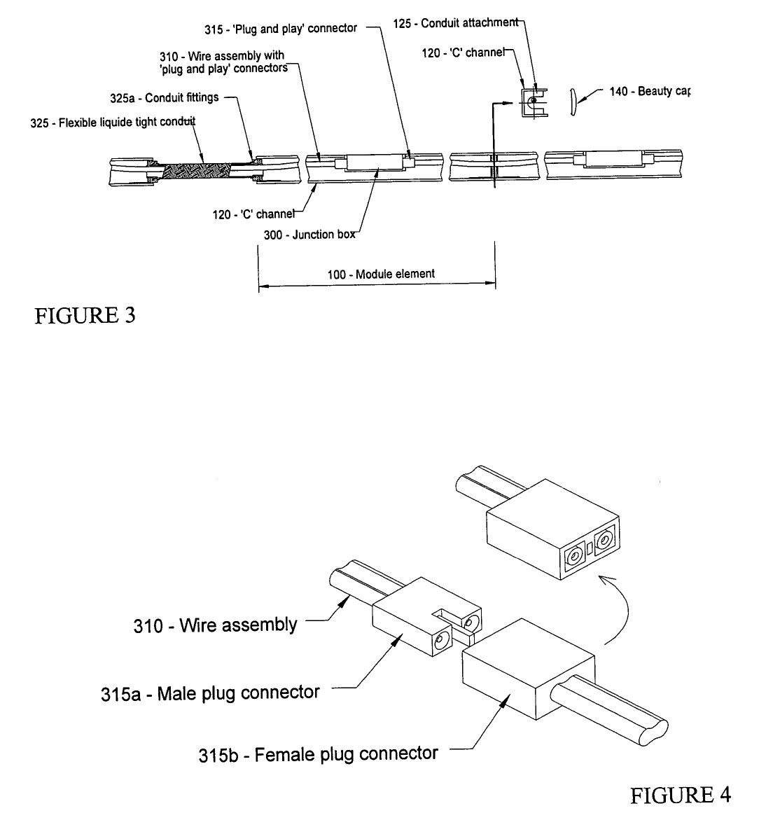

Referring to FIG. 2, a preferred array is shown that includes four modules elements 100 that are mounted using the clamping system 200. The clamp system 200 is used to securely mount a module element 100 to an installation surface, e.g. a roof of a building. The clamp system 200 is accessible from the visible top of the panel elements 100 and provides an easy assembly or disassembly using only human hand force. The array of module elements 100 can be arranged either horizontally or vertically: the modules can each have ‘C’ shaped channels 120 that are aligned so as to provide a wire raceway that runs the lengths of the module array, as shown in FIG. 2. At approximately the midpoint of the ‘C’ shaped channels 120, a junction box 300 can be provided for enclosing the electrical connections. After making all required electrical connections, a cap 140 can be installed, to enclose the channels and thereby prevent severe environmental conditions from adversely affecting the wiring running in the ‘C’ channel.

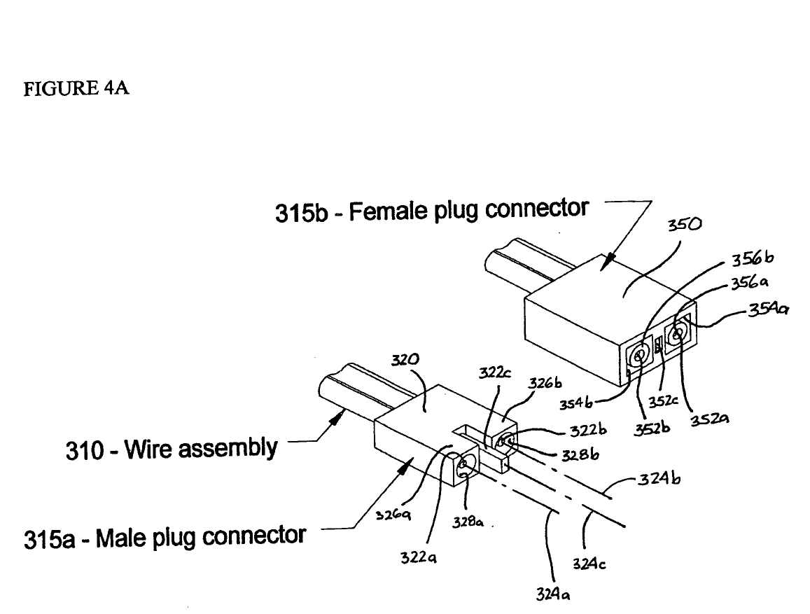

Referring additional to FIG. 3, a wire assembly 310 completes the electrical circuit of the system. Each module will have at least one wire assembly 310. The wire assembly 310 can use three conductors, e.g., stranded copper from AWG 12 to AWG 6, THHN or THWN. The wire assembly 310 can have a jacket that is U resistant, e.g., types US, USE or UF. The three conductors will be positive, negative and ground. Each wire assembly 310 can have a pre-attached plug connector 315 on each end. The plug connector 315 is a one-way, touch safe plug. The plug connector 315 will pass UL1703 tests and be NEC compliant. Male and female components are connected to form the plug connector assemblies. Preferably, female receptacles will be in the junction box 300, field combiner box(es) 600 and inverter box 800, and the wire assemblies 310 will have male ends. A female-to-female connector can also be provided to connect two male ends and extend the pre-assembled wire assemblies 310.

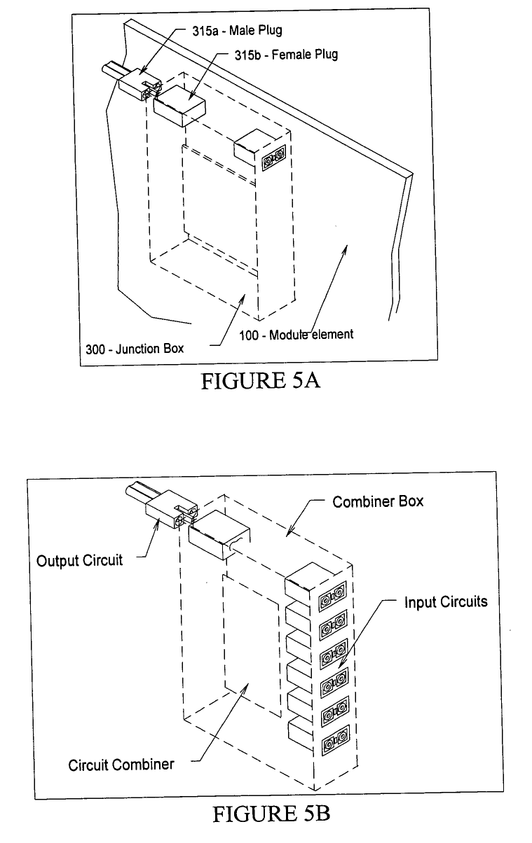

Referring to FIGS. 4 and 4A, the plug connector 315 includes a male plug connector 315a and a cooperatively mating female plug connector 315b. The plug connector 315 include polarized male 315a and female 315b multiple conductor connectors that facilitate quick and easy connection and disconnection in a single possible relative orientation, and without the use of tools.

According to the preferred embodiments of the present invention, the photovoltaic electrical wiring system provides an electrical circuit that electrically couples all of photovoltaic components together, provides a weather proof, secure and safe method of completing the electric circuit of a solar electric system, and includes positive, negative and ground connections.

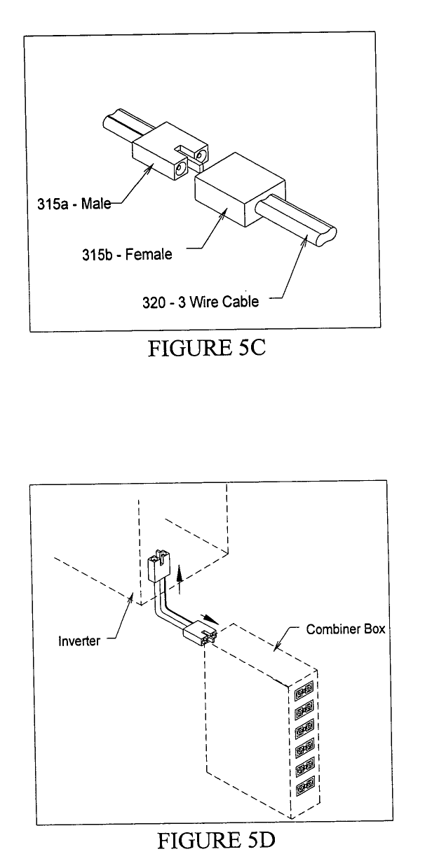

The photovoltaic system wiring will be simplified with the use of pre-assembled wiring assemblies 310 consisting of wires and male plug connectors 315a/female plug connectors 315b that fit into their respective counterparts in the solar electric photovoltaic system. Thus, the wiring assemblies 310 can connect the junction boxes 300 located on the module elements 100, can connect the module frame to the module frame connection points, can connect ‘in-line’ to extend the wire lengths, can connect the combiner boxes in the photovoltaic system, and can connect into the inverter. Examples of such connections are shown in FIGS. 5A-5D. In particular, the plug connection 315 according to the present invention is designed to perform a number of functions, including: 1) plug into the photovoltaic module junction boxes 300, as shown in FIG. 5A; 2) plug into photovoltaic field combiner boxes, as shown in FIG. 5B; 3) plug into itself; e.g., so as to provide extended the wiring in the field, as shown in FIG. 5C; and 4) plug into the DC/AC inverter used in photovoltaic systems, as shown in FIG. 5D.

The plug connector 315 uses a three-conductor wiring system designed to be plugged in one direction, i.e., to eliminate cross-polarized connections. The three conductors are positive (+), negative (−), and ground leads. All conductors and connections will have the protection from the elements such as—water, e.g., moisture, sunlight resistant, e.g., UV, heat resistant, e.g., will keep connection intact even at high temperature, dust particles and condensation. Also the connections will provide a safe and easy installation such as-one way plug only, ground connection will be make first and break last, electrical spark free connect and disconnect, interlocking between male and female plugs for the appropriate strain relief of the connections.

Referring particularly to FIG. 4A, the male plug connector 315a includes an electrically non-conductive body that supports three electrically conductive male prongs 322a,322b,322c, e.g., the body can have a base portion 320 that is molded around the male prongs 322a,322b,322c so as to encase respective electrical couplings between the wires and the prongs. The male prongs 322a,322b,322c extend from the base portion 320 along respective axes 324a,324b,324c, which are parallel to one another. According to a preferred embodiment, polarization of the plug connector 315 is established by offsetting the ground prong 322c with respect to the male prongs 322a,322b such that the axis 324c is spaced from a plane defined by the axes 324a,324b.

The body also includes a first tube 326a that projects from the base portion 320 and surrounds the first male prong 322a, and includes a second tube 326b that projects from the base portion 320 and surrounds the second male prong 322b. Gaps between inner surfaces 328a,328b of the corresponding tubes 326a,326b and the respective male prongs 322a,322b define annular spaces that preferably extend in the tubes 326a,326b to the base portion 320.

According to a preferred embodiment, the lengths of the projections of the first and second male prongs 322a,322b from the base portion of the body 320 are generally equal, the length of the projection of the ground prong 322c from the base portion of the body 320 is greater than the projection lengths of the first and second male prongs 322a,322b, and the first and second tubes 326a,326b extend from the base portion of the body 320 by at least the lengths of the first and second male prongs 322a,322b. Consequently, the first and second male prongs 322a,322b are substantially shielded from incidental contact that could cause a short circuit, and the ground prong 322c is the first to be contacted and the last to have its contact broken.

The female plug connector 315b includes an electrically non-conductive body 350 that supports three electrically conductive female receptacles 352a,352b,352c, e.g., the body 350 can be molded around the female receptacles 352a,352b,352c so as to encase respective electrical couplings between the wires and the receptacles. The body 350 also includes first and second recesses 354a,354b and respective first and second insulators 356a,356b extending in the corresponding recesses 354a,354b. Preferably, the body 350 shields the female receptacles 352a,352b,352c from incidental contact that could cause a short circuit.

According to a preferred embodiment, when the male and female plug connectors 315a,315b are coupled together, the following relationships exist: 1) the first male prong 322a is electrically coupled with the first female receptacle 352a; 2) the second male prong 322b is electrically coupled with the second female receptacle 352b; 3) the third male prong 322c is electrically coupled with the third female receptacle 352a; 4) the first insulator 356a is received in the annular space between the inner surface 328a of the tube 326a and the male prong 322a; 5) the second insulator 356b is received in the annular space between the inner surface 328b of the tube 326b and the male prong 322b; 6) the first tube 326a is received in the first recess 354a; and 7) the second tube 326b is received in the second recess 354b.

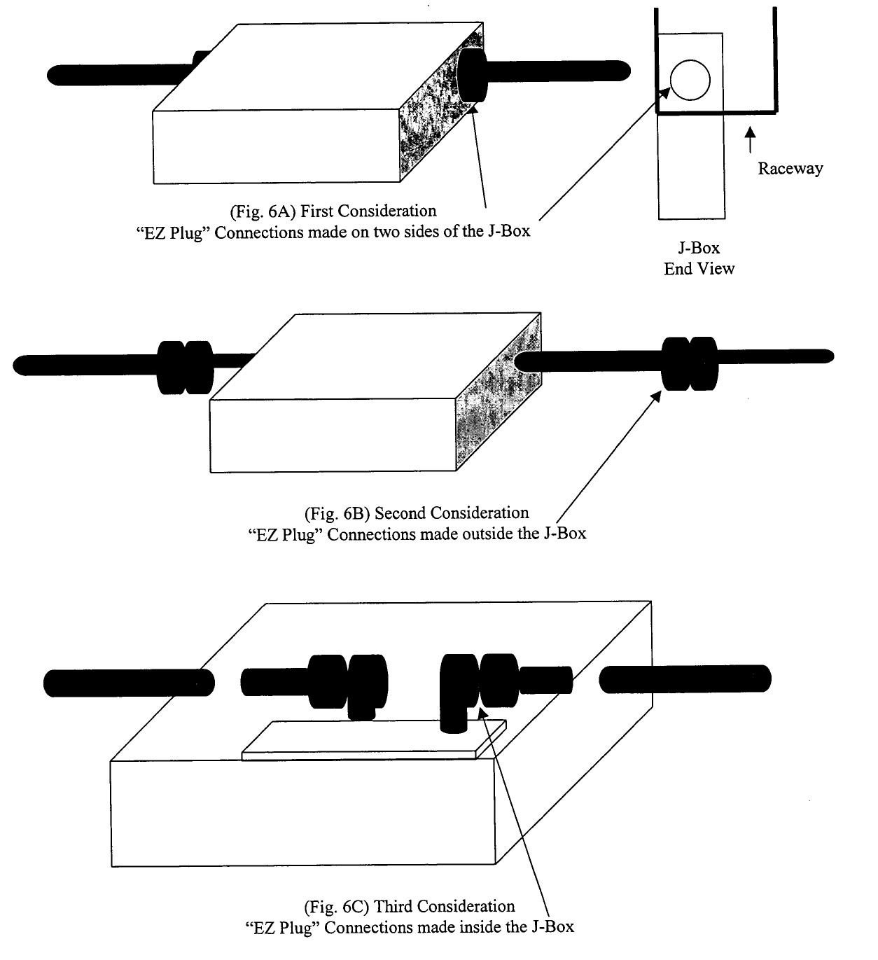

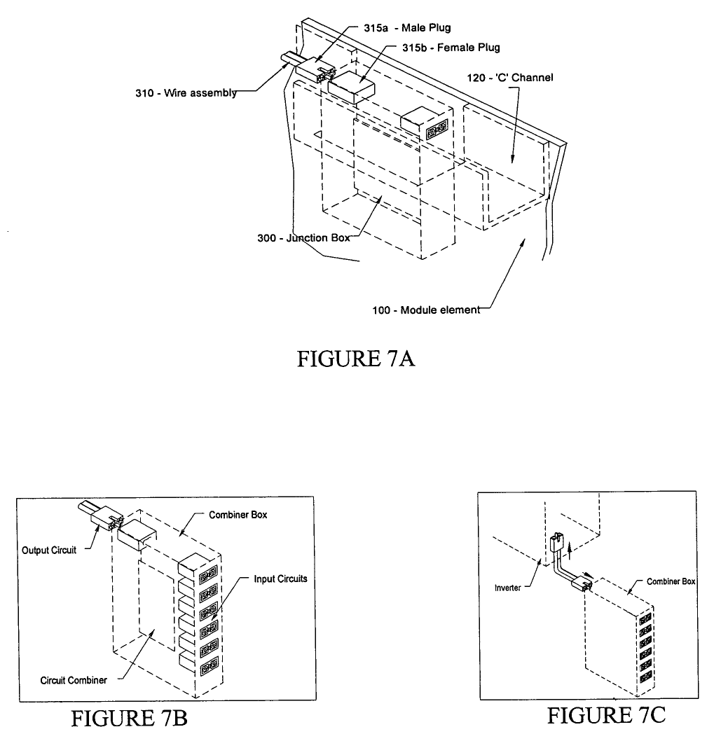

A method of electrically connecting a photovoltaic system according to the present invention will now be described and illustrated in FIGS. 2 and 6A-6C. For the sake of this example, it is assumed that there are four photovoltaic modules mounted adjacent to one another, and that an individual performing this method would have a simple sketch or diagram identifying the photovoltaic modules 1-4, junction box 300 locations and jumper cable sketch. A preferred sequence of steps for making the electrical connections in a photovoltaic system using four photovoltaic modules 100 is:

1. Locate the junction boxes on photovoltaic module #1. Preferably, each photovoltaic module has two junction boxes mounted at either end.

2. Thread one end of the 5.5′ cable jumper through the C-channel raceway.

3. Remove the retainer/waterproof cover from the junction box located on top of the photovoltaic module #1 (protection of the junction box when no wires are installed)

4. Insert the plug end of the cable jumper into junction box receptacle. There will be only one jumper cable per junction box for photovoltaic module #1.

5. Place the retainer/waterproof cover over the plug and tighten the hold down screws (rather than screws, a snap-in can be used)

6. Thread a second jumper cable through the C-channel raceway leading to the adjacent photovoltaic module # 2.

7. Remove the retainer/waterproof cover from the junction box located on top of the photovoltaic module.

8. Insert the plug end of the cable jumper into junction box receptacle.

9. Before replacing the retainer/waterproof cover, thread a jumper cable from the opposite side of photovoltaic module #2 and plug into the second receptacle of top junction box.

10. Place the retainer/waterproof cover over the two plugs and tighten the hold down screws.

11. Repeat the above steps 6 through 10 for the remaining adjacent photovoltaic modules until all of the receptacles of the top junction box have been connected.

12. The jumper cable coming from photovoltaic module #4 will connect to a field combiner box 600.

13. Locate the bottom junction box on photovoltaic module #1.

14. Repeat steps 2-12.

15. Connect one end of the home run cable 700 to the field combiner box 600.

16. Connect the other end of the home run cable to the inverter 800.

17. Connect the inverter 800 to the utility breaker panel 950 via the utility disconnecting device 900.

18. Switch ON the utility disconnecting device 900.

According to the preferred embodiments, the final installation cost can be reduced. For example, one way to reduce cost is to provide jumper wire assemblies 315 of predetermined lengths. The jumper wire assemblies 315 can be manufactured in high volumes in order to obtain the lowest possible cost. Of course, special jumper wire assemblies 315 lengths are possible but at a lower-volume/higher-cost factor, which may or may not have a negative impact on the over all cost.

Preferably, modules will be placed close to each other and the wire assembly 310 will be pre-assembled with some extra length. Also available will be jumper wires or extension wires of various lengths. Some runs will require conduit to be connected to the raceways—this can be provided as a pre-assembled unit or as plug ‘ends’. Modules will be placed in rows above each other; the modules can be connected from row to row using a flexible liquid tight conduit and pre-assembled wire assembly 310.

Of course a number of variations and equivalents are envisioned. For example, the male connector plug 315a may include female receptacles and then the female connector plug 315b would include male prongs. A positive locking arrangement, e.g., threaded connections or “press-to-release” engagements, may be provided to prevent the male and female plug connectors 315a,315b from becoming disconnected. And the relative lengths of the prongs, tubes, receptacles and insulators may be varied. It is preferable, according to the present invention, that these variations and equivalents 1) provide a universal connection system that is utilized by all of the direct current components of the photovoltaic system; 2) be polarized to prevent incorrect mating of the male and female pug connectors 315a,315b; 3) be connected and disconnected by hand, i.e., without tools; 4) prevent inadvertent contact with the terminals that could cause short circuiting; and 5) join together all the positive, negative and ground electrical conductors in a single step procedure.

A number of advantages are achieved according to the present invention. These advantages include that the components of the photovoltaic system can be electrically connected without tools or additional fixtures, e.g., screwdrivers, wire nuts, etc., uses a “universal” connector plug that ensures the correct polarity is observed, and provides a common ground system for the direct and alternating current sides of the photovoltaic system.

Other advantages that are achieved include eliminating service time and improving safety by virtue of the service person being able to easily and safely, e.g., with minimal shock hazard, disconnect and connect photovoltaic modules or other components of the photovoltaic system.

According to the preferred embodiments, wiring is completed using plug connectors that are polarized and cannot be fit into the module but one way. The installer will plug one end of the wire system into one module, using the wire raceway to route the wires to the next module and plug the other end of the wire assembly into the next module. Thus, according to the present invention, there are no tools, no errors with cross polarity, and the electrical connections are fast, simple, safe (since there are no open wires for shock hazard).

Additional advantages of the plug system according to the preferred embodiments include reduced manufacturing and installation costs. Reductions in manufacturing costs can be achieved with a crimp style contact design for automatic termination, which reduce labor and improve quality versus conventional contact designs that us screw machine/hand solder termination, and with post molded plug housing that eliminate additional “O” rings for sealing and a separate water tight boot. Reductions in installation cost can be achieved by eliminating expensive electricians at the job site and by lowering the final assembly time.

While the present invention has been disclosed with reference to certain preferred embodiments, numerous modifications, alterations, and changes to the described embodiments are possible without departing from the sphere and scope of the present invention, as defined in the appended claims. Accordingly, it is intended that the present invention not be limited to the described embodiments, but that it have the full scope defined by the language of the following claims, and equivalents thereof.

What we claim is:

1. A system of electrically connecting a photovoltaic module, the photovoltaic module includes a plurality of photovoltaic cells and a frame mechanically coupling the plurality of photovoltaic cells, each of the plurality of photovoltaic cells receives solar energy and outputs direct current electricity, the outputs of the plurality of photovoltaic cells are combined and provided at a photovoltaic module positive and photovoltaic module negative nodes, the system comprising:
a wire assembly consisting essentially of:
a first wire extending between respective first and second ends, the first end of the first wire being electrically coupled to the photovoltaic module positive node;
a second wire extending between respective first and second ends, the first end of the second wire being electrically coupled to the photovoltaic module negative node; and
a third wire extending between respective first and second ends, the first end of the third wire being electrically coupled to the frame of the photovoltaic module; and
a first plug connector including a set of terminals arranged in a relative pattern, the set of terminals consisting essentially of:
a first terminal electrically coupled to the second end of the first wire;
a second terminal electrically coupled to the second end of the second wire; and
a third terminal electrically coupled to the second end of the third wire.

2. The system according to claim 1, wherein the wire assembly comprises a sheath commonly encasing the first, second and third wires, and the first, second and third wires are electrically insulated from one another within the sheath.

3. The system according to claim 1, wherein the first plug connector comprises an electrically non-conductive first body supporting each of the first, second and third terminals.

4. The system according to claim 3, wherein the first terminal comprises one of a male prong and a female receptacle, the second terminal comprises one of a male prong and a female receptacle, and the third terminal comprises one of a male prong and a female receptacle.

5. The system according to claim 4, wherein the first, second and third terminals comprise first, second and third male prongs, respectively, the first male prong extending along a first prong axis, the second male prong extending along a second prong axis, and third male prong extending along a third prong axis, and the first, second and third axes being parallel.

6. The system according to claim 5, wherein the first and second axes define a plane, and the third axis is spaced from the plane.

7. The system according to claim 5, wherein the first body of the first plug connector comprises a base portion encasing and electrically insulating the electrical couplings of the first terminal to the second end of the first wire, the second terminal to the second end of the second wire, and the third terminal to the second end of the third wire.

8. The system according to claim 7, wherein the first terminal projects from the base portion a first length, the second terminal projects from the base portion a second length, and the third terminal projects from the base portion a second length.

9. The system according to claim 8, wherein the first and second lengths are substantially equal.

10. The system according to claim 9, wherein the third length is greater than the first and second lengths.

11. The system according to claim 8, wherein the body of the first plug connector comprises first and second tubes projecting from the base portion, the first tube extending at least the first length along the first prong axis and surrounding the first prong, and the second tube extending at least the second length along the second prong axis and surrounding the second prong.

12. The system according to claim 11, wherein the first and second tubes comprises first and second gaps, respectively, the first gap being defined by a first annular space between the first male prong and a first inner surface of the first tube, and the second gap being defined by a second annular space between the second male prong and a second inner surface of the second tube.

13. The system according to claim 12, further comprising:
a second plug connector including an electrically non-conductive second body, a first female receptacle receiving the first male prong, a second female receptacle receiving the second male prong, and a third female receptacle receiving the third male prong, a first configuration of the first and second plug connectors preventing electrical communication between the first, second and third male prongs and the first, second and third female receptacles, respectively, and a second configuration of the first and second plug connectors permitting electrical communication between the first, second and third male prongs and the first, second and third female receptacles, respectively.

14. The system according to claim 13, wherein the second body comprises first and second recesses, the first recess surrounding the first tube in the second configuration of the first and second plug connectors, and the second recess surrounding the second tube in the second configuration of the first and second plug connectors.

15. The system according to claim 14, wherein the second body comprises first and second insulators, the first insulator surrounding the first female receptacle and extending in the first recess, the second insulator surrounding the second female receptacle and extending in the second recess, the first insulator being received in the first gap in the second configuration of the first and second plug connectors, and the second insulator being received in the second gap in the second configuration of the first and second plug connectors.

16. The system according to claim 15, wherein the first recess including a first depth at least as great as the first length, the second recess including a second depth at least as great as the second length, the first insulator extending a first distance approximately equal to the first depth, and the second insulator extending a first distance approximately equal to the second depth.

17. The system according to claim 14, wherein the second body further comprises an aperture through which the third male prong passes to engage the third female receptacle in the second configuration of the first and second plug connectors.

18. The system according to claim 13, further comprising:
a first junction box mechanically coupled to one of the first and second plug connectors.

19. 18, wherein the first junction box is mechanically coupled to one each of the first and second plug connectors.

20. The system according to claim 18, further comprising:
a second junction box mimicking the first junction box, and the first and second junction boxes being positioned at different locations on the photovoltaic module.

21. The system according to claim 20, wherein the first and second junction boxes being positioned at opposite ends of the photovoltaic module.

22. The system according to claim 18, wherein the first junction box is mechanically coupled to a sole first one of the first and second plug connectors and mechanically coupled to a plurality of a second one of the first and second plug connectors, and each of the plurality of the second ones of the first and second plug connectors are electrically connected to the sole first one of the first and second plug connectors.

23. The system according to claim 13, further comprising:
a lock preventing the first and second plug connectors from being reconfigured from the second configuration to the first configuration.

24. The system according to claim 3, wherein each of the first, second and third terminals comprise respective female receptacles.

25. A photovoltaic module for mounting on a structure, the photovoltaic module comprising:
first and second module faces and an edge that extends between the first and second module faces, the first module face receiving solar energy and the second module face being adapted to generally confront the structure;
a plurality of photovoltaic cells being commonly supported by a base, each of the photovoltaic cells converting the solar energy to electricity; and
a junction box supported on the base along the edge and shielding electrical couplings to the plurality of photovoltaic cells; the junction box including a first one of a male plug connector and a female plug connector, the first one of the male and female plug connectors being accessible from the first module face and being adapted to matingly couple with a second one of the male and female plug connectors so as to output the electricity from the e plurality of photovoltaic cells.

26. The photovoltaic module according to claim 25, further comprising:
a manual attachment, the manual attachment being adapted to releasably secure the base with respect to the mounting element.

27. A kit comprising:
a photovoltaic module including:
first and second module faces and an edge that extends between the first and second module faces, the first module face receiving solar energy;
a plurality of photovoltaic cells being commonly supported by a frame, each of the plurality of photovoltaic cells receives solar energy and outputs direct current electricity, the outputs of the plurality of photovoltaic cells are combined and provided at photovoltaic module positive and photovoltaic module negative nodes; and
a junction box supported on the frame along the edge, the junction box shielding the photovoltaic module positive and photovoltaic module negative nodes; the junction box including a first one of a male plug connector and a female plug connector, the first one of the male and female plug connectors being accessible from the first module face; and
a wire assembly including:
a second one of the male and female plug connectors matingly coupling with the first one of the male and female plug connectors, the second one of the male and female plug connectors including a set of terminals consisting essentially of first, second, and third terminals.

28. The kit according to claim 27, wherein the wire assembly comprises a cable, the cable consisting essentially of:
a first wire extending from the first terminal and being electrically coupled to the photovoltaic module positive node;
a second wire extending from the second terminal and being electrically coupled to the photovoltaic module negative node; and
a third wire extending from the third terminal and being electrically coupled to the frame of the photovoltaic module.

29. A method of electrically connecting direct current components of photovoltaic system mounted on a structure including an alternating current electrical system, the direct current components of the photovoltaic system including a photovoltaic module including a frame, a photovoltaic module positive node and photovoltaic module negative node, the method comprising:
mounting the photovoltaic module with respect to the structure; and
electrically connecting without tools the photovoltaic module to another one of the direct current components.

30. The method according to claim 29, wherein the electrically connecting comprises coupling a plug connector to the photovoltaic module, the coupling consists essentially of:
electrically coupling a first wire to the photovoltaic module positive node,
electrically coupling a second wire to the photovoltaic module negative node; and
electrically coupling a ground wire to the frame of the photovoltaic module.

31. The method according to claim 30, wherein the coupling comprises mechanically coupling the plug connector to the photovoltaic module.

32. The method according to claim 30, wherein the electrically coupling the ground wire to the frame of the photovoltaic module comprises grounding the frame of the photovoltaic module with respect to the alternating current electrical system.
